(19) United States
(12) Patent Application Publication
(10) Pub. No.: US 2010/0227596 A1
(43) Pub. Date: Sep. 9, 2010

(54) Method and system to enable users to request for a specific content, action and information over a Bluetooth Network

(75) Inventor: Narasimha Suresh, Bangalore (IN)

Correspondence Address: Rahman LLC, 10025 Governor Warfield Parkway, Suite 110, Columbia, MD, 21044, US

(73) Assignee: Telibrahma Convergent Communications Private Limited, Bangalore (IN)

(21) Appl. No.: 12/399,925

(22) Filed: Mar. 7, 2009

(51) Int. Cl. H04M 3/493; H04B 7/00; H04W 4/12

(52) U.S. Cl. 455/414.2; 455/41.2; 455/466

(57) ABSTRACT

Embodiments herein disclose a method and system for a user to access content and information present on the content server on his communication device without having subscribed to any data access plans or without installation of any application on his communication device. A Bluetooth terminal, which is connected to the communication device using a Bluetooth connection, pushes a page to the device. The page has been encoded so that when the user clicks a link on the page or requests for more information from the page, a message is generated and is sent to the central server. The central server, on receiving the message, generates a response and sends the page, which has been specially coded to the communication device through the Bluetooth terminal using the Bluetooth connection.

### FIELD OF INVENTION

The embodiments herein generally relate to Bluetooth systems, and, more particularly, to providing content to a user using Bluetooth.

### BACKGROUND AND PRIOR ART

Through advances in communication technologies, it is now possible for users with mobile communication devices to access content of their interest according to various services provided by service providers. Presently, mobile communication devices have technologies and protocols like Wireless Application Protocol (WAP), General Packet Radio Service (GPRS), Short messaging service (SMS), and Bluetooth for accessing various services to enable users to access content.

With existing technologies, users may access content according to their requirement using GPRS or WAP protocols. However, accessing information on communication devices requires cellular operator to enable such service. Also, users are charged an additional amount according to the content received.

Users may also request content by sending a query through a Short Message Service (SMS) message and receiving a response in the form of a SMS to the query. For example, if a user is interested in checking a game score, he may be able to send a pre-defined message to a short code and the user would be sent another SMS with scores and any other relevant information that may be of interest to the user. SMS is limited in its ability to deliver content as SMS is only capable of delivering plain text content and not of any kind of rich media content. Further, user will also be charged an additional amount according to the content received by him.

Also, if an operator has not exposed location based information, content delivered in that mechanism would not be localized. The information accessed by the user through his communication device may not be location specific, for example, a user accessing the internet in Bangalore, India to search for a Chinese restaurant will get search results that may not be necessarily in Bangalore and hence of low significance to him. The user will be more interested in obtaining a list of Chinese restaurants in Bangalore, and more specifically interested in getting the list of Chinese restaurants in the vicinity of his present location.

There are methods by which a user can install an application on the communication device and through the application access information using Bluetooth protocol that may allow the user to access relevant content. However, installing an application may be a tedious process for most users. Further in such an operation, a Bluetooth system would not be able to know information relating to the mobile device of the users to be able to provide customized services specific to devices.

### SUMMARY OF INVENTION

In view of the foregoing, an embodiment herein provides a method for a user to access information using a communication device, the communication device connected to a Bluetooth network, the Bluetooth network comprising of a plurality of Bluetooth terminals and at least one server, the method comprising steps of the server sending a first page to the communication device through the Bluetooth terminal; the user requesting for information from the server using the page; the server fetching the requested information; the server coding the information; and the server sending the information to the communication device, through the Bluetooth terminal. The first page, which could be a web page or a Wireless Application Protocol (WAP) page, is created by the server based on location of the communication device, past behavior of the user and so on and comprises of a unique identification for the communication device. The user requests for information using the page by clicking on links available in the page and the requests from the user are sent to the server using Short Messaging Service (SMS). The server may fetch information from a local server or from the internet. The coding of the information by the server comprises steps of the server coding the information onto a page; the server modifying links present on the page; wherein the links can be used by the user to request for information; and adding options to the page.

Embodiments herein also disclose a method of simplifying user interactions through Bluetooth, the method comprising the steps of providing at least one central server, for providing content to a plurality of communication devices, providing at least one Bluetooth terminal, for interfacing between the central server and the plurality of communication devices; where the central server sends a first page to the communication device through the Bluetooth terminal using Bluetooth, which may be a web page or a Wireless Application Protocol (WAP) page; a user of a communication device requesting for information from the central server by clicking on links available on the page and the requests being sent to the central server using Short Messaging Service (SMS); the central server fetching the requested information, either from the internet or from a local server; the central server coding the information; and the central server sending the information to the communication device, through the Bluetooth terminal. The first page is created by the central server based on location of the communication device, past behavior of the user and comprises of a unique identification of the communication device. The coding of the information by the central server comprises steps of the central server coding the information onto a page; the central server modifying links present on the page; wherein the links can be used by the user to request for information; and adding options to the page.

Embodiments herein also disclose a server, the server connected to a plurality of Bluetooth terminals, wherein the server with the plurality of Bluetooth terminals form a Bluetooth network, wherein a user through a communication device is connected to the Bluetooth network; the server comprising of a coding means for coding information requested by the user into a page; a modification means for modifying links present in the page, wherein the links can be used by the user to request for information from the server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following description with reference to the drawings, in which:

FIG. 1 illustrates a Bluetooth network, in accordance with various embodiments disclosed herein;

FIG. 2 illustrates a schematic diagram depicting a method for a user to access information, in accordance with various embodiments disclosed herein;

FIGS. 3(A) and 3(B) illustrates a flow chart depicting a method for a user to access information, in accordance with various embodiments disclosed herein;

FIG. 4 illustrates a Bluetooth network, in accordance with various embodiments disclosed herein;

FIG. 5 illustrates a schematic diagram depicting a method for a user to access information, in accordance with various embodiments disclosed herein; and

FIGS. 6(A) and 6(B) illustrates a flow chart depicting a method for a user to access information, in accordance with various embodiments disclosed herein.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

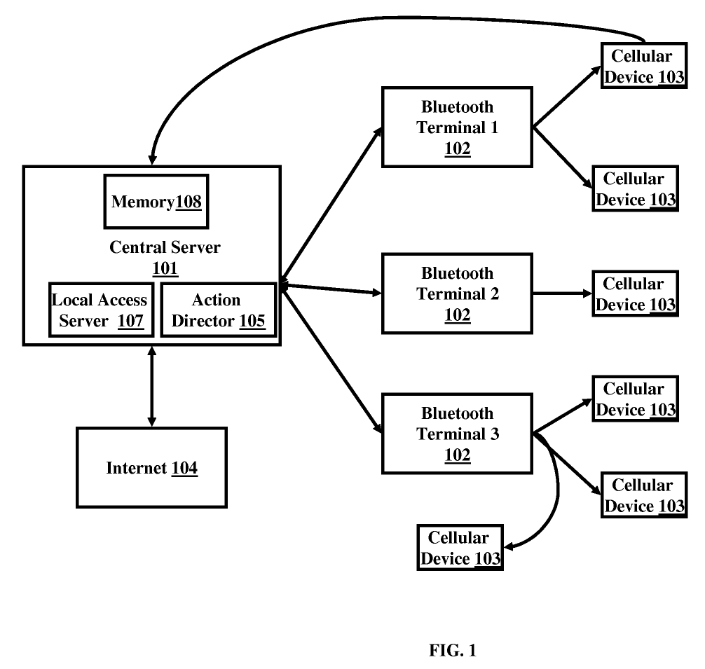

The embodiments herein achieve a method and system for providing content, information to a user or perform an action using a Bluetooth network. Referring now to the drawings, and more particularly to FIGS. 1 through 6(B), where similar reference characters denote corresponding features consistently throughout the figures, there are shown preferred embodiments.

Embodiments herein disclose a method and system for a user to access content and information on his communication device without having subscribed to any data access plans or without installation of any application on his communication device. The network comprises of plurality of Bluetooth terminal which provide Bluetooth coverage to a particular area or a locality and a central server, to which the Bluetooth terminals are connected and controlled. The server comprises of a Mobile originated (MO) and Mobile Terminated (MT) interface to a SMS gateway. The server uses the MO interface to receive SMS from end users mobile device and deliver relevant information to the user mobile using SMS through the MT interface. A Bluetooth terminal, which is connected to the communication device using a Bluetooth connection, pushes a page to the device. The page has been encoded so that when the user clicks a link on the page or requests for more information from the page, a message is generated and is sent to the central server. The central server, on receiving the message, generates a response and sends the page, which has been specially coded to the communication device through the Bluetooth terminal using the Bluetooth connection.

FIG. 1 illustrates a Bluetooth network, in accordance with various embodiments disclosed herein. The elements as depicted in FIG. 1 are a central server 101, a plurality of Bluetooth terminals 102, a plurality of communication devices 103 and the internet 104. The Bluetooth terminal 102 pushes a specially coded page to the communication device 103 over the Bluetooth connection. The page may comprise of basic information, with links which enable the user of the communication device 103 to request for more information or links which the user can access further information. The page may also present the user with further options like requesting access to local information like traffic conditions, weather conditions, asking for more options to be presented etc. The page also comprises of a unique ID, which is coded from the MAC ID of the communication device 103. The central server 101 and the Bluetooth terminal 102 decide on the page which is to be sent to the communication device 103 on factors like the location of the device, environment, past user behavior and so on. When a user clicks on a link in the page or selects an option on the page, which has been sent to him by the terminal 102, a HTTP message is sent by the communication device 103 to the central server 101. The HTTP message may be in the form of a request HTTP message and comprises the unique ID of the communication device 103. The central server 101 on receiving the HTTP message from the communication device 103, stores the request and the unique ID in a memory 108. Relevant information of the communication device 103 like the MSISDN number may also be stored in the memory 108 which may aid in checking factors like past user behavior etc. The central server 101 comprises of an action director 105 to direct the messages, content or information to be sent to the device on the handheld device according to the requests received from the user. The action director 105 might contain a rule engine to decide on the first page which is to be sent to the communication device 103 on factors like the location of the device, environment, past user behavior and so on. The central server 101 retrieves the information from the local content server 107, if present or from the internet 104. The server 101 codes the information onto a page, modifying the links present in the page so as to enable the user to request information using HTTP messages and adding further options to the page. The page is also stored in the memory 108 for future use. The server 101 then forwards the page to the Bluetooth terminal 102, which in turn forwards the same to the communication device 103 using the Bluetooth connection. The user can further request for more information and content using the links present on the page, as sent to him by the server 101.

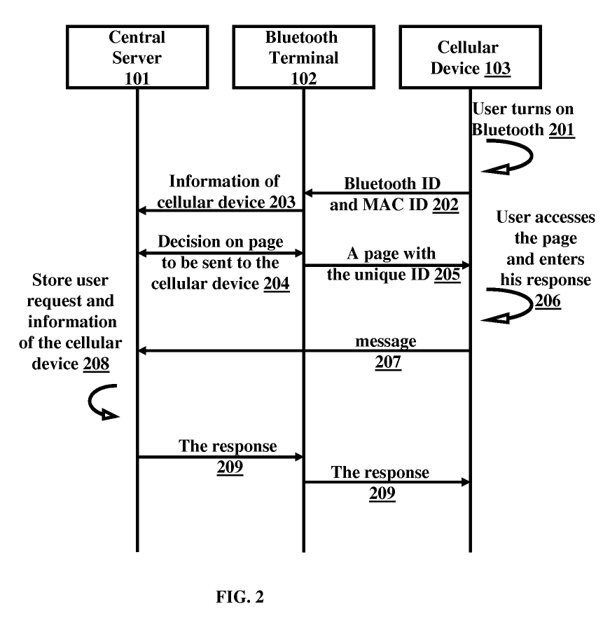

FIG. 2 illustrates a schematic diagram depicting a method for a user to access information, in accordance with various embodiments disclosed herein. A user turns (201) Bluetooth ON on his communication device 103. The communication device 103 sends (202) the Bluetooth ID and MAC ID of the device 103 to the nearest Bluetooth terminal 102. The Bluetooth terminal 102 forwards (203) the information sent by the device 103 to the central server 101 and is stored in the server 101. The server 101 along with the terminal 102 makes (204) a decision on the page to be sent to the user based on factors like the location of the device, environment, past user behavior and so on. The page comprising of the information like the unique ID of the device 103 is sent (205) to the device 103 by the terminal 102. The user accesses the page and makes (206) a request by clicking on a link in the page or selecting an option on the page, which has been sent to him by the terminal 102, a request is sent (207) by the communication device 103 to the central server 101. The central server 101 on receiving the HTTP message from the communication device 103, stores (208) the request, the unique ID and any other information in the memory 108. The central server 101 retrieves the information from the local content server 107, if present or from the internet 104. The server 101 codes the information onto a page, modifying the links present in the page so as to enable the user to request information using messages and adding further options to the page. The page is also stored in the memory 108 for future use. The server 101 then forwards (209) the response in the form of a page to the Bluetooth terminal 102, which in turn forwards (209) the same to the communication device 103 using the Bluetooth connection. The user can further request for more information and content using the links present on the page, as sent to him by the server 101.

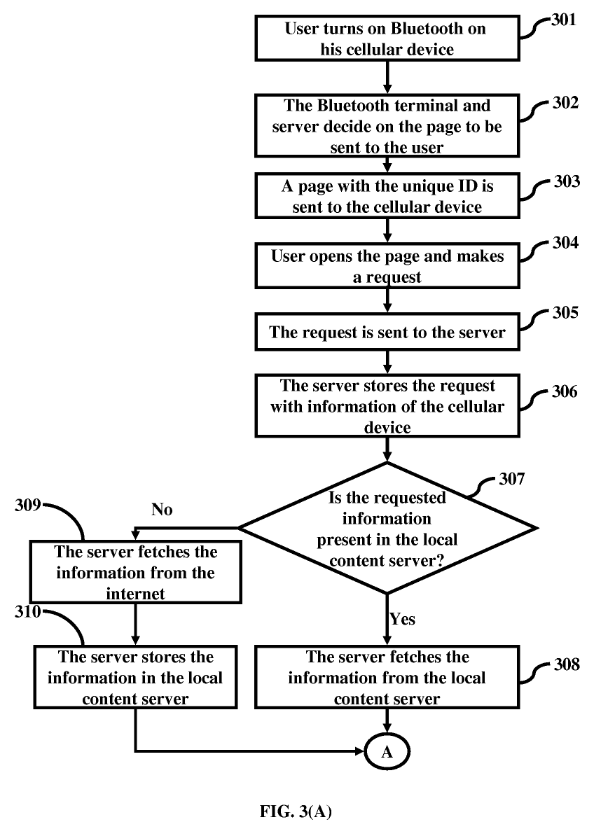

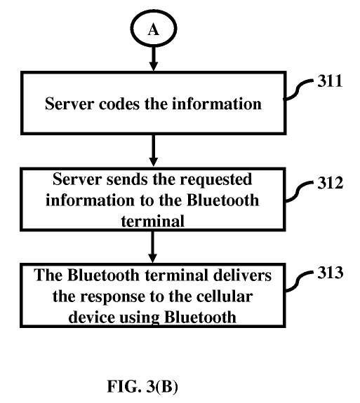

FIGS. 3(A) and 3(B) illustrate a flow chart depicting a method for a user to access information, in accordance with various embodiments disclosed herein. A user turns (301) Bluetooth ON on his communication device 103. The Bluetooth terminal 102 forwards the information sent by the device 103 to the central server 101 and is stored in the server 101. The server 101 along with the terminal 102 decides (302) the page to be sent to the user based on factors like the location of the device, environment, past user behavior and so on. The page comprising of the information like unique ID of the device 103 is sent (303) to the device 103 by the terminal 102. The page can be rendered on the communication device of the user using a Wireless Application Protocol (WAP) browser or a Hyper Test Markup Language (HTML) browser. The user accesses the page and makes (304) a request by clicking on a link in the page or selecting an option on the page, which has been sent to him by the terminal 102, a request in the form of a HTTP message is sent (305) by the communication device 103 to the central server 101. The central server 101 on receiving the HTTP message from the communication device 103, stores (306) the request, the unique ID and any other information in the memory 108. The server 101 checks (307) if the requested information is present in the local content server 107. If the requested information is present in the local content server 107, then the server 101 fetches (308) the requested information from the local content server 107. If the requested information is not present in the local content server 107, then the server 101 fetches (309) the requested information from the internet 107 or any other source of information. The server 102 also stores (310) the page in the local content server 107 for future use. The server 101 codes (311) the fetched information onto a page, modifying the links present in the page so as to enable the user to request information using messages and adding further options to the page. The server 101 then forwards (312) the requested information in the form of a page to the Bluetooth terminal 102, which in turn forwards (313) the same to the communication device 103 using the Bluetooth connection. The user can further request for more information and content using the links present on the page, as sent to him by the server 101.

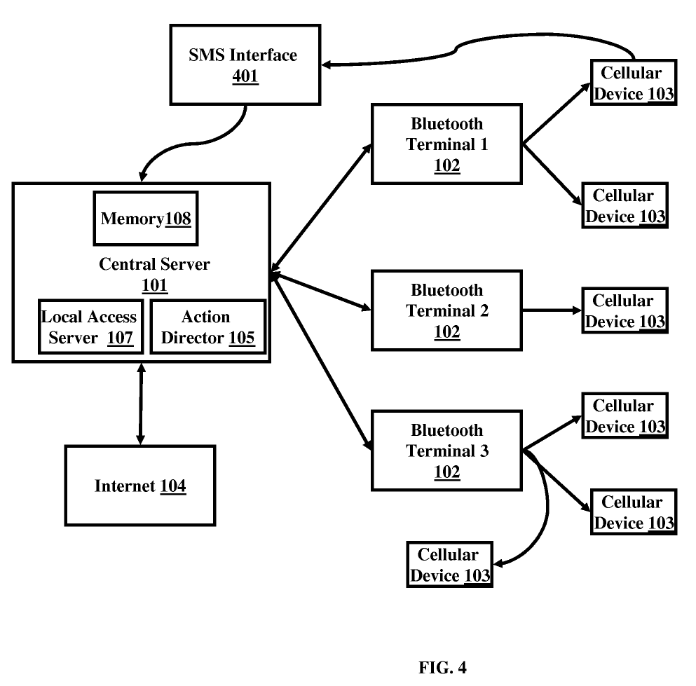

FIG. 4 illustrates a Bluetooth network, in accordance with various embodiments disclosed herein. The elements as depicted in FIG. 4 are a central server 101, a plurality of Bluetooth terminals 102, a plurality of communication devices 103, a Short Message Service (SMS) interface 401 and the internet 104. A communication device 103, belonging to a user is connected using Bluetooth to the Bluetooth terminal 102, where the Bluetooth terminal 102 is aware of the Media Access Control (MAC) ID of the communication device. The Bluetooth terminal 102 pushes a specially coded page to the communication device 103 over the Bluetooth connection. The page may comprise of basic information, with links which enable the user of the communication device 103 to request for more information or links which the user can access further information. The page may also present the user with further options like requesting access to local information like traffic conditions, weather conditions, asking for more options to be presented etc. The page also comprises of a unique ID, which has been coded from the MAC ID of the communication device 103. The central server 101 and the Bluetooth terminal 102 decide on the page which is to be sent to the communication device 103 on factors like the location of the device, environment SMS interface 401. The SMS message comprises of the unique ID of the communication device 103. The central server 101 on receiving the SMS message from the communication device 103 via the SMS interface 401, stores the request, the unique ID and any other information in a memory 108. Relevant information of the communication device 103 like the MSISDN number may also be stored in the memory 108 which may aid in checking factors like past user behavior etc. The central server 101 comprises of an action director 105 to direct the messages, content or information to be sent to the device on the handheld device according to the requests received from the user past user behavior and so on. The central server 101 retrieves the information from a local content server 107 in the server, if present or from the internet 104. The server 101 codes the, past user behavior and so on. The page can be rendered on the communication device of the user using a Wireless Application Protocol (WAP) browser or a Hyper Test Markup Language (HTML) browser. When a user clicks on a link in the page or selects an option on the page, a SMS message is sent by the communication device 103 to the central server 101 through the information onto a page, modifying the links present in the page so as to enable the user to request information using SMS messages and adding further options to the page. The server 101 then forwards the page to the Bluetooth terminal 102, which in turn forwards the same to the communication device 103 using the Bluetooth connection. The user can further request for more information and content using the links present on the page, as sent to him by the server 101. The action director 105 might contain a rule engine to decide on the first page which is to be sent to the communication device 103 on factors like the location of the device, environment,

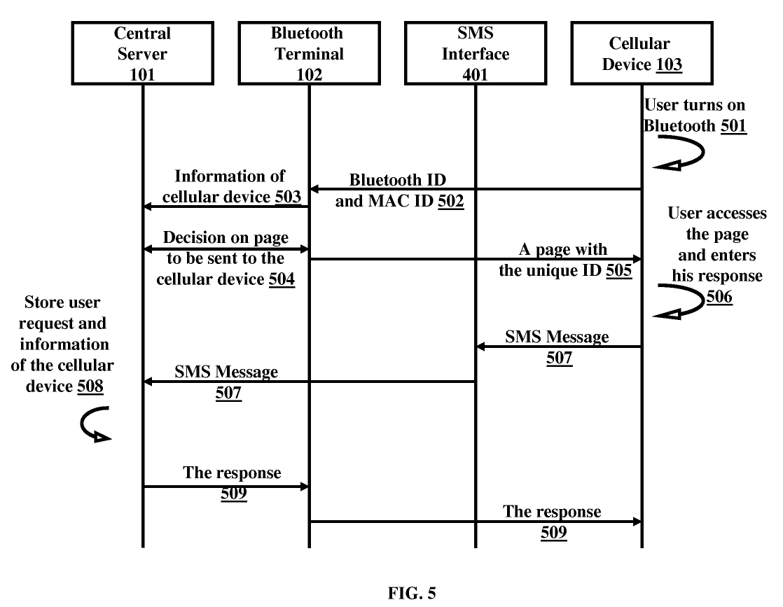

FIG. 5 illustrates a schematic diagram depicting a method for a user to access information, in accordance with various embodiments disclosed herein. A user turns (501) Bluetooth ON on his communication device 103. The communication device 103 sends (502) the Bluetooth ID and MAC ID to the nearest Bluetooth terminal 102. The Bluetooth terminal 102 forwards (503) the information sent by the device 103 to the central server 101 and is stored in the server 101. The server 101 along with the terminal 102 makes (504) a decision on the page to be sent to the user based on factors like the location of the device, environment, past user behavior and so on. The page comprising of the information like MAC ID of the device 103 is sent (505) to the device 103 by the terminal 102. The page can be rendered on the communication device of the user using a Wireless Application Protocol (WAP) browser or a Hyper Test Markup Language (HTML) browser. The user accesses the page and makes (506) a request 101 on receiving the SMS message from the communication device 103 via the SMS interface 401, stores (508) the request, the unique ID and any other information in the memory 108. The central server 101 retrieves the information from the local content server 107, if present or from the internet 104. The server 101 codes the information onto a page, modifying the links present in the page so as to enable the user to request information using SMS messages and adding further options to the page. The page is also stored in the memory 108 for future use. The server 101 then forwards (509) the response in the form of a page to the Bluetooth terminal 102, which in turn forwards (509) the same to the communication device 103 using the Bluetooth connection. The page can be rendered on the communication device of the user using a Wireless Application Protocol (WAP) browser or a Hyper Test Markup Language (HTML) browser. The user can further request for more information and by clicking on a link in the page or selecting an option on the page, which has been sent to him by the terminal 102, a request in the form of a SMS message is sent (507) by the communication device 103 to the central server 101 through the SMS interface 401. The central server content using the links present on the page, as sent to him by the server 101.

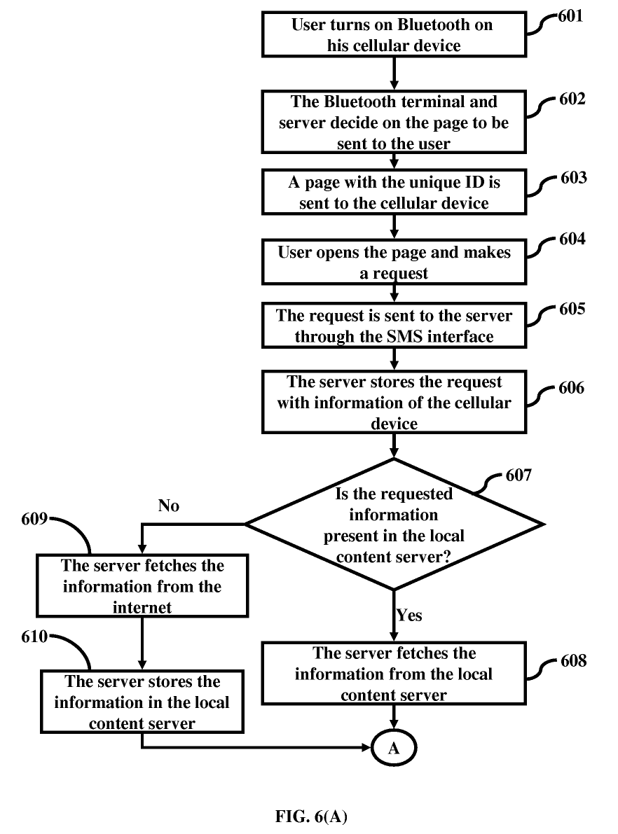

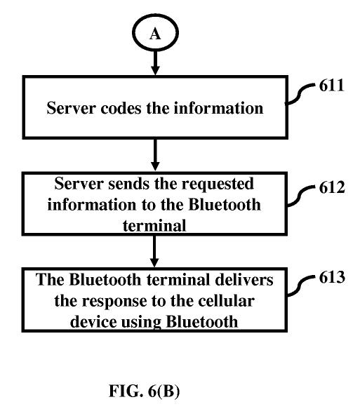

FIGS. 6(A) and 6(B) illustrate a flow chart depicting a method for a user to access information, in accordance option on the page, which has been sent to him by the terminal 102, a request in the form of a SMS message is sent (605) by the communication device 103 to the central server 101 through the SMS interface 401. The central server 101 on receiving the SMS message from the communication device 103 via the SMS interface 401, stores (606) the request, the unique ID and any other information in the memory 108. The server 101 checks (607) if the requested information is present in the local content server 107. If the requested information is present in the local content server 107, then the server 101 fetches (608) the requested information from the local content server 107. If the requested with various embodiments disclosed herein. A user turns (601) Bluetooth ON on his communication device 103. The communication device 103 sends the Bluetooth ID and MAC ID to the nearest Bluetooth terminal 102. The Bluetooth terminal 102 forwards the information sent by the device 103 to the central server 101 and is stored in the server 101. The server 101 along with the terminal 102 decides (602) the page to be sent to the user based on factors like the location of the device, environment, past user behavior and so on. The page comprising of the information like the unique ID of the device 103 is sent (603) to the device 103 by the terminal 102. The user accesses the page and makes (604) a request by clicking on a link in the page or selecting an information is not present in the local content server 107, then the server 101 fetches (609) the requested information from the internet 107 or any other source of information. The server 102 also stores (610) the page in the local content server 107 for future use. The server 101 codes (611) the fetched information onto a page, modifying the links present in the page so as to enable the user to request information using SMS messages and adding further options to the page. The server 101 then forwards (612) the response which may be in the form of a page or any possible variation to the Bluetooth terminal 102, which in turn forwards (613) the same to the communication device 103 using the Bluetooth connection. The user can further request for more information and content using the links present on the page, as sent to him by the server 101.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the disclosed invention.

What is claimed is:

1. A method for a user to access information using a communication device, said communication device connected to a Bluetooth network, said Bluetooth network comprising of a plurality of Bluetooth terminals and at least one server, said method comprising steps of:
said server sending a first page to said communication device through said Bluetooth terminal;
said user requesting for information from said server using said page;
said server fetching said requested information;
said server coding said information; and
said server sending said information to said communication device, through said Bluetooth terminal.

2. The method as claimed in claim 1, wherein said first page is created by said server based on location of said communication device.

3. The method as claimed in claim 1, wherein said first page is created by said server based on past behavior of said user.

4. The method as claimed in claim 1, wherein said first page comprises of a unique identification of said communication device.

5. The method as claimed in claim 1, wherein said first page can be rendered by a Hyper Text Markup Language (HTML) browser.

6. The method as claimed in claim 1, wherein said first page can be rendered by a Wireless Application Protocol (WAP) browser.

7. The method as claimed in claim 1, wherein said Bluetooth terminal sends said first page to said communication device using Bluetooth.

8. The method as claimed in claim 1, wherein said user requests for information using said page by clicking on links available on said page.

9. The method as claimed in claim 1, wherein requests for information from said user are send to server using Short Messaging Service (SMS).

10. The method as claimed in claim 1, wherein said server fetches information from a local server.

11. The method as claimed in claim 1, wherein said server fetches information from the internet.

12. The method as claimed in claim 1, wherein coding of said information by said server comprises steps of:
said server coding the information onto a page;
said server modifying links present on said page; wherein said links can be used by said user to request for information; and
adding options to said page.

13. A method of simplifying user interactions through Bluetooth, the method comprising the steps of:
providing at least one central server, for providing content to a plurality of communication devices, providing at least one Bluetooth terminal, for interfacing between said central server and said plurality of communication devices;
where
said central server sends a first page to said communication device through said Bluetooth terminal;
a user of a communication device requesting for information from said central server using said page;
said central server fetching said requested information;
said central server coding said information; and
said central server sending said information to said communication device, through said Bluetooth terminal.

14. The method as claimed in claim 13, wherein said first page is created by said central server based on location of said communication device.

15. The method as claimed in claim 13, wherein said first page is created by said central server based on past behavior of said user.

16. The method as claimed in claim 13, wherein said first page comprises of a unique identification of said communication device.

17. The method as claimed in claim 13, wherein said first page can be rendered by a Hyper Text Markup Language (HTML) browser.

18. The method as claimed in claim 13, wherein said first page can be rendered by a Wireless Application Protocol (WAP) browser.

19. The method as claimed in claim 13, wherein said Bluetooth terminal sends said first page to said communication device using Bluetooth.

20. The method as claimed in claim 13, wherein said user requests for information using said page by clicking on links available on said page.

21. The method as claimed in claim 13, wherein requests for information from said user are send to said central server using Short Messaging Service (SMS).

22. The method as claimed in claim 13, wherein said central server fetches information from a local server.

23. The method as claimed in claim 13, wherein said central server fetches information from the internet.

24. The method as claimed in claim 13, wherein coding of said information by said central server comprises steps of:
said central server coding the information onto a page;
said central server modifying links present on said page; wherein said links can be used by said user to request for information; and
adding options to said page.

25. A server, said server connected to a plurality of Bluetooth terminals, wherein said server with said plurality of Bluetooth terminals form a Bluetooth network, wherein a user through a communication device is connected to said Bluetooth network; said server comprising of:
a coding means for coding information requested by said user into a page;
a modification means for modifying links present in said page, wherein said links can be used by said user to request for information from said server.
